(19) United States
(12) Patent Application Publication
(10) Pub. No.: US 2006/0119002 A1
(43) Pub. Date: Jun. 8, 2006

(54) Thin, stratified, reinforced slab and method for the manufacture thereof

(76) Inventor: Luca Toncelli, Bassano Del Grappa (Vicenza) (IT)

Correspondence Address: KATTEN MUCHIN ROSENMAN LLP, 575 MADISON AVENUE, NEW YORK, NY, 10022-2585, US

(21) Appl. No.: 11/329,448

(22) Filed: Jan. 11, 2006

Related U.S. Application Data
(63) Continuation of application No. PCT/EP04/08242, filed on Jul. 23, 2004.

(30) Foreign Application Priority Data
Jul. 29, 2003 (IT) TV 2003A000108

(51) Int. Cl. B28B 1/08; B29C 33/58; B28B 1/16

(52) U.S. Cl. 264/316; 264/256; 264/257; 264/258; 264/69; 264/102

(57) ABSTRACT

Between two layers (10, 12) of Bretonstone™ mix—formed by inert materials (11), a hardening resin and a filler (13)—at least one fibrous middle layer (14) is arranged which consists of linear elements or inorganic filaments (15), preferably made of glass and in the form of continuous non-woven elements, pre-impregnated with a resin of the same kind as, or compatible with that forming the said mix. The assembly is subjected to vacuum vibro-compression before a final hardening step in a catalysis oven. USE/ADVANTAGES: a stratified and reinforced slab is obtained which combines a reduced thickness (even as small as 3.5 mm) to a very high impact strength and improved mechanical properties.

The present invention relates to an improved slab of composite stone material or conglomerate and to the method for the manufacture thereof.

More specifically, the present invention relates to a reinforced slab of stone material which has a small thickness and optimum mechanical properties, in particular impact breaking strength.

For many years now a technology for the manufacture of slabs of composite stone material known by the name of “Bretonstone™ System” has been developed and become established industrially. With this technology it is possible to obtain slabs with large dimensions, for example 120×300 cm or 140×300 cm.

This technology envisages using a mix consisting of inert materials and a cement binder or a binder consisting of a synthetic resin with the addition of fillers.

In the case of the present invention the technology based on the use of a synthetic resin as binder is of sole interest.

In short, this technology envisages that the mix, which is deposited in a suitable thickness inside a forming support, preferably in the form of two rubber sheets with dimensions matching those of the final slab desired, is subjected inside a vacuum chamber to the action of a press, the ram of which is kept vibrating at a predefined frequency.

After the vacuum compaction accompanied by a vibratory movement, the resulting slab is transferred to a hot hardening station where, owing to the effect of heat, the resin hardens. The slab is then freed from the rubber sheets so that it can be conveyed away for the normal finishing operations (such as sizing, polishing, etc.).

The plants for implementing this technology have numerous stations in each of which the steps described above are performed.

As mentioned, the starting mix or “mixture” consists of inert materials and structural contact resins, in the liquid state, with a filler. In the remainder of this description this mix will be referred to as “Bretonstone mix”.

The inert materials may consist of siliceous or calcareous natural stone materials or artificial materials such as glass and ceramic materials.

Shells, corals, madrepore, etc., may also be used.

First of all, the raw inert materials are crushed.

The inert materials may be monogranular in size, understood as meaning a material formed by fragments of similar dimensions, for example fragments ranging from 1 to 2 millimetres, or 3 to 5 millimetres, or 0.1 to 0.2 millimetres.

The dimensions of the inert materials may also be classified according to broader, continuous or discontinuous granulometric scales, such as, for example, a mixture of fragments with dimensions of 0.1 to 0.3/0.3 to 0.7/0.7 to 1.2, etc. or 0.1 to 0.3/1.2 to 2.5/2.5 to 4.0. millimeters, etc.

The nature, dimensions and granulometric scales of the inert materials used in the mixtures are in each case chosen by the formulating technician on the basis of the aesthetic effects and the physical, chemical and mechanical characteristics which are to be obtained in the finished product.

The maximum dimension of the inert materials may not be greater than the rough-cast thickness of the formed slab.

The fillers consist of powders obtained from ground natural or artificial stone materials having dimensions of between 1 and 99 micron.

It is also possible to use as fillers silica fume, fly ash, talc, barium sulphate, metakaolins, titanium oxides, corundum, silicon carbide and other agents, intended to obtain products with a particular appearance and/or characteristics.

The dimensions and quantity of the filler in the mixture must be compatible with those of the inert materials, namely the particles of filler—even when the product to be made is formed with the volumetrically maximum possible amount of inert materials—must be able to be inserted with maximum filling of the interstices between one particle of inert materials and the next.

Usually, fillers of a nature similar to that of inert materials are used.

For example, fillers obtained from ground silica, quartz or quartzite are used when the inert materials is of a siliceous nature in order to obtain products which are uniformly resistant to chemical agents, to atmospheric agents and to wear.

For the same reasons, a filler of calcium carbonate or magnesium carbonate is commonly used when the inert materials have a similar nature or resistance to the said aggressive agents.

With regard to inert materials, it is worth noting that those particles with a size ranging between 100 microns and 6 millimetres are commonly called “sand” and that inert materials with dimensions of up to 6 millimetres are usually used in the manufacture of the Bretonstone slabs.

The resins more often used are unsaturated polyester resins, epoxy systems and acrylic resins, although this list must not be regarded as limiting.

The mixtures are formulated in such a way that, after their compaction into slabs, the inert materialss are homogeneously divided within the mass, thus occupying the predefined volume thereof.

Their maximum quantity obviously cannot exceed their capacity for filling a given volume, which is determined by the best mutual intersection of the individual particles of inert materials. It should be noted that the term “intersection” is understood as meaning the choice of fractions of inert materials of different particle sizes such as to obtain maximum filling of the available volume. In order to determine the intersection, the formulating technician in each case will apply the criteria which are well-known in the art, using for example Bolomey's or Fuller's formula.

The binding paste comprised in the mixture is formed by fillers and liquid structural resins and must be of a quantity sufficient to fill entirely all interstices existing between the various particles of inert materials, adhering perfectly to the surface of each individual particle, joining and uniting them without interruption.

In any mixture, the volumes of inert materials. Fillers and resins must be proportioned relative to each other so as to ensure, within the mass to be compacted, the free movement or the best relative configuration of the particles of inert materials in the mix.

When formulating the mixtures, structural resins are employed with a viscosity such as to allow them, during mixing, to be uniformly diffused within the mixture, lining each individual particle of filler with a thin sticky layer.

The mixture, during the various stages of its preparation, transportation, distribution and compaction, does not exude liquid and remains homogeneous; after compacting thereof by means of vacuum vibro-compression it is converted into a compact slab which is likewise homogeneous throughout its mass.

The mixtures may be and actually are coloured, as required, by means of inorganic and/or organic pigments in powder or paste form. Two or more mixtures which are monochromatic, of varying colour or even mixtures formed with inert materials of varying grain size may be mixed together in varying proportions and intensity so as to obtain slabs with different colour effects and compositions from these mixtures.

The mixture, as ready to be compacted, is in the form of an incoherent loose mix which, when compressed in the hand, forms large porous and friable lumps.

This incoherent state facilitates the conveying and spreading out flat of the mixture and allows a complete deaeration of the mass before and during compaction, so as to prevent any porosity in the finished product.

The density of the mixture is much less than the density of the slab resulting from its compaction by means of vacuum vibro-compression.

The ratio between apparent volume of the uncompacted mixture and real volume of the compacted mixture normally varies between 1.7 and 2.2.

For example, assuming as the specific weight of a given type of slab made with quartz and resin a value of 2.38 (about 83% of filler and inert materials with specific weight of about 2.65+about 17% of unsaturated polyester resin with specific weight of 1.12), 1000 cubic centimeters of loose mixture may weigh about 1082 to 1400 grams.

During manufacture of the slabs a certain quantity of mix (“dosed amount”) is distributed within the forming support in order to obtain a slab of predetermined dimensions and thickness.

The dosed amount is spread out flat, as uniformly as possible, within a space having dimensions matching those of the slab which is to be obtained.

The dosed amount is spread over a sheet of rubber or other elastomer having a suitable thickness—for example 4 millimetres—with or without containing edges, resting on a conveyor belt for transfer to the downstream methoding stations.

Another sheet of rubber or other suitable elastomer is placed onto the free surface of the spread out mix.

A thin layer of plastic material, having a separating function as well as that of protecting the rubber sheets from the styrene vapours and the abrasive action of the inert materials, is applied beforehand onto the surface facing the mix of the two rubber sheets, i.e. the bottom sheet and top sheet.

The dosed amount of mix lying on the lower sheet and covered by the upper sheet is transferred by means of the conveyor belt into a compacting machine provided with a vibrating and pressing ram which is housed and operated within a vacuum chamber.

When the dosed amount reaches a position coinciding with the ram of the machine, the chamber containing the ram is closed and emptied of air. Once the desired degree of vacuum is reached, the press ram rests on the sheet lying above the surface of the dosed amount and compacts said dosed amount by means of the combined vibrating and compressing action, converting the dosed mixture into a compacted slab of predetermined size and thickness.

When the slab is fully and thoroughly compacted, the ram is moved out of the slab surface, the machine opens and the slab, by means of the conveyor belt, leaves the machine to be transferred to the subsequent station for performing the hardening method, which is preferably performed at high temperature.

This hardening station preferably consists of a series of pairs of adjacent heating plates which are kept in perfect contact with the surfaces of the slab until the hardening method is performed as a result of polymerization of the resin forming the mixture.

Each hardened slab is extracted from the associated pair of heating plates and released from the two rubber sheets between which it was first formed and then hardened.

The sheets of rubber are returned for subsequent use in the forming cycle, subsequent to in line application of the abovementioned plastic protective film.

For example this protection may consist of a film of modified plasticized PVA with a thickness of 40 μm (such as that described in Italian Patent No. 1,311,857), which is very extendable and insensitive to the action of the heat and solvents, for example the styrene monomer.

This film has the function of protecting the surface of the rubber both from attack by styrene, which would otherwise cause rapid degradation thereof, and from mechanical abrasion otherwise caused by the vibrating/pressing contact of the particles of inert materials with the rubber.

Moreover, owing to the fact that it adheres to the surface of the rubber sheets without remaining bonded thereto, during catalysis of the resin forming part of the mixture, the protective film does not oppose the volumetric contraction of the slab, but spontaneously follows said contraction without tearing, despite the varying contraction and elongation of the rubber sheet and the slab when the latter is hardening and subsequently cooling.

The hardened slab, once released from the rubber sheets, is cooled and soon after machined (smoothed, polished, cut to size) or stored in rough form.

The entire method is completed within about 100 to 120 seconds in the sense that, during this time interval, one hardened slab is obtained.

Normally the slabs are manufactured in the dimensions most required by the market, depending on their applications, i.e. 120×300 cm and 140×300 cm, but obviously any other dimension is feasible.

The slabs obtained using this technology have optimum structural characteristics. For example, slabs made of quartzm:

have a flexural strength in the range of about 45 to 90 N/mm²;

have an impact strength, for the same thickness, at least triple that of the most compact natural stones or porcelain gres;

show a good resistance to acids, to alkali, to oils and non-absorbance of water or other liquids;

easily attain a gloss exceeding 60 gloss;

are able to withstand, practically unchanged over time, wear and degradation due to use and being walking on;

may be produced with a wide range of aesthetic effects.

These slabs have been very successful for house equipment: in particular, they are used in the manufacture of tops for bathrooms and kitchens since they have a surface unaffected by contact with oils and acids, do not wear and have an attractive aesthetic appeal.

In the building industry the slabs are used as a substitute for natural stone, not only because of their improved physical and mechanical properties, but also because of the extreme ease of machining, the aesthetic uniformity of the production batches, the reliability and repeatability of the samples, the Constance of dimensions, the lack of breakages and machining waste.

The slabs obtained using the conventional Bretonstone technology described above are produced with a thickness of at least 10 millimetres. The manufacturers propose them with thicknesses of 10 and 15 millimetres for floors and of 20 and 30 millimetres for articles for other uses in the building industry and for furnishing complements, competing with success with any other stone material.

It would be desirable, however, and is a main aim of the present invention, to produce slabs which, while maintaining the same aesthetic and technical qualities as the conventional slabs described above, are of a very low thickness, for example 3.5 or 5 or even 6 millimetres, and have an exceptional impact strength so as to be be handled without the risk of breakage.

A second aim of the invention is to obtain floor tiles from such very thin and very strong slabs which may be laid on top of old floors to be replaced, without the need for costly demolition work.

A further aim of the invention is to line with these thin slabs either one or both the opposite surfaces and the edges of light panels, with a specific weight of, for example, 700 to 1,000 g/dm³, in order to produce bathroom and kitchen furniture, tables, showers, lifts, interior walls, doors and cabinets, by placing them and/or gluing them onto walls or other surfaces of a lower quality, making them more attractive.

A futher aim of the invention is to make available slabs of a very low thickness and extremely high breaking strength which may be modelled, cut, shaped, handled, transported, packaged and overlaid on any structure without breakage, and may be cut to size and/or perforated, also in situ, using a simple manual tool.

It is obvious that the production of these thin, large-size, strong and aesthetically very attractive slabs results in the availability of a semi-finished material, which can be used for the most widely varying end products in easy way and at a low cost, thus attaining remarkable cost-related advantages.

For example, the price of thin tiles may be partly offset by the savings resulting from elimination of the costs of demolition of old floors, creating a greater added value, while laying is extremely economical.

It has been found—said finding being the subject of the present invention—that the abovementioned objects may be achieved by a thin, stratified and reinforced, consisting of two outer layers and at least one resistant middle layer, characterized in that said outer layers and said at least one middle layer consist of the same permanently hardened mix, comprising inert materials and a binding resin and in that the mass of said middle layer is a fibrous layer where linear elements or filaments are embedded and adherent thereto, the said linear elements or filaments having a sinuous configuration and being inorganic or organic with equivalent properties, as well as pre-impregnated with a resin of the same kind as or at least compatible with that of the mix.

In a preferred embodiment of the present invention, said inorganic elements are used in the form of a web or several webs forming a bundle.

The present invention differs from a development of the above cited “Bretonstone” technology which is disclosed in WO 01/45291 and consists in a slab of an agglomerate formed by inorganic materials in granular and/or powder form, with the optional addition of filamentous inorganic materials, and by binding materials, at least one foil of thermoplastic material being associated to said slab, either externally or embedded.

The invention also relates to a method for manufacturing said thin reinforced slabs, characterized in that, during the operations described above relating to the Bretonstone technology, an additional step is introduced, upstream of the step involving compaction of the mixes by means of vacuum vibro-compression, consisting in arranging at least one or more webs arranged in bundle form within the thickness of the dosed mix which is spread over the rubber or elastomer sheet, each of said webs being formed by non-woven filaments which are inorganic or organic with equivalent properties, having a sinuous configuration, being preferably continuous and made of glass, and pre-impregnated with a resin of the same kind as or at least compatible with that forming the mix, so that said web or bundle of webs undergoes the same treatment as the mix and in particular the vacuum vibro-compression step.

Said webs, as a result of the vacuum vibro-compression, are penetrated and permeated by the mix so that the sinuous linear elements, being mutually spaced transversely relative to the manufactured article, become an integral part of the mix, said webs permeated with mix in the centre of the article forming a resistant structure having a thickness greater than the web or bundle of webs. Thanks to said resistant structure, which is of the same nature and composition as the outer layers but has running through it said filaments which form a whole with the mix which surrounds them and to which they adhere, the resulting article is homogeneous, continuous and dimensionally stable.

In the above definitions reference has been made to inorganic fibres or organic fibres with equivalent properties, this latter expression being understood as referring to fibres such as carbon or aramid fibres which may replace the inorganic fibres.

The manufacturing method according to the present invention therefore envisages the following steps:

(a) the two sheets of rubber are prepared, i.e. a bottom sheet on which the mix must be spread and a top sheet intended to cover the mix spread over the bottom sheet;

(b) a separating and protective agent is spread over the surface of each rubber sheet intended to be placed in contact with the mix, such as the already mentioned aqueous solution of modified PVA according to Italian patent 1,311,857, which forms a protective film as a result of evaporation;

(c) the bottom rubber sheet is placed on the surface of the conveyor belt of the manufacturing plant, in a similar manner to that which occurs in Bretonstone technology;

(d) a quantity of mix formed by resin of a suitable viscosity, fillers and inert materials, equal to half of the quantity needed for manufacturing a slab of the desired thickness, is spread in a uniform thickness over the bottom rubber sheet;

(e) one or more webs arranged in bundle form are deposited on the surface of the layer of mix, each web being formed by non-woven inorganic filaments, for example and preferably continuous with a sinuous configuration and made of glass, pre-impregnated with a resin not yet polymerized of the same kind as or compatible with that forming the mix;

(f) the second layer of mix, in the same quantity as the first layer, is spread on top of the said web or said webs, again with a uniform thickness;

(g) the top rubber sheet is placed on top of the surface of the second layer of mix;

(h) the two rubber sheets, which enclose the sandwich formed by the two layers of mix and the web of impregnated filaments arranged in between, are transferred under the ram of the machine for compaction by means of vacuum vibro-compression, where the layers of mix are compacted and interpenetrate each other, embedding the pre-impregnated filaments which form the web, the impregnating resin of which, not yet hardened, bonds with the resin with which the mix is formed;

(i) once the compaction step has been completed, the not yet hardened compacted slab is transferred into the catalysis oven, comprising pairs of adjacent heating plates between which the slab is enclosed and heated to temperatures of between 80 and 130° C. for a time period of between 10 and 20 minutes depending on the previously selected hardening curve;

(j) when the slab has hardened, it is extracted from the pair of heating plates which enclosed it and freed from the two rubber sheets which contained it in order to be conveyed away for storage or directly for the surface finishing, sizing and shaping operations.

It should be noted that the non-woven filaments of glass inserted inside the mix do not hinder the natural reduction in volume of the article during catalysis, thus avoiding any warping effect. On the contrary, a web of interwoven strands would be resistant during the compaction step and retain its configuration, with the result of preventing the mix from penetrating through the strands, thus eliminating any uneveness in the thickness of the slab; this, in addition, would create obstacles and deformations during catalysis.

As regards the vibro-compression step (sometimes also called vibro-compaction step), it is performed at a frequency of between 2000 and 3600 cycles per minute, depending on the composition of the mix, for a time period of between 45 and 90 seconds, in this case also depending on the composition of the mix.

The overall pressure which the ram exerts on the mix is determined by the pulsating force of the vibrating/pressing mass, which has a value varying between 0 and 2.1 kg/cm² and by the pressing force resulting from the pressure difference between the vacuum chamber inside which the ram operates and the environment outside the vacuum chamber, which acts on the external surface of the ram.

According to a preferred mode of implementing the method of the invention, in order to ensure a layer of mix with a uniform thickness over the whole of the surface in question, namely the surface of the bottom rubber sheet and the surface of the web or bundle of webs forming the middle layer (during the step following deposition thereof), before spreading the mix a grid is placed on the surface of the bottom rubber sheet. Said grid is of a suitable thickness, for example 7.5 mm, is preferably made of steel strips, having a thickness for example of 3 mm, in order to provide the grid with the necessary strength and rigidity. The grid cells are of predefined dimensions, for example 50×50 mm. During the above mentioned spreading step (d), the individual cells are filled with mix, said filling being performed with several successive passes by a self-propelled dispensing device performing a to-and-fro movement along the whole grid. The uniformity of thickness of the mix is obtained owing to the grid cells which prevent the mix, which is of a very low thickness, from sliding on the surface of the rubber sheet.

Once the spreading step (d) has been completed, all that is required is to remove the grid by raising it, so that the layer of mix lying on the bottom rubber sheet is in the form of small plates corresponding to the design and to the dimensions of the grid cells which are separated from one another by a gap corresponding to the thickness of the strips which form the grid.

After deposition of the web or bundle of webs according to step (e), a metal roller is made to pass several times with a to-and-fro movement over the surface of the web of filaments causing said small plates to merge together. Thus the density of the mix from which the small plates are formed is increased while the volume only reduced by the amount necessary for the layer of mix to assume a consistency suitable for the following step (f) where the second half-dose of mix is spread.

In fact, in this step also, the cellular grid is arranged again on the free surface of the web or bundle of webs and the same procedure as that described above takes place.

However, a rolling step after each deposition may be advantageous in order to ensure the uniformity of thickness of each layer of mix even in the case where the layers are deposited using different procedures.

As regards the composition of the mix it preferably comprises:

(a) an unsaturated polyester resin, having a suitable viscosity (for example 650 cps, in a quantity constituting at least 15% of the total volume of the mix, preferably a quantity of between 16 and 20% by volume);

(b) a filler chosen from among those mentioned above, preferably consisting of quartz ground to a fineness of about 25,000 mesh and in a quantity equivalent to at least 16% by volume of the total volume of the mix, preferably between 17 and 24% by volume;

(c) inert materials, consisting preferably of quartz sand with a grain size calculated in accordance with Bolomey's or Fuller's formula, with a dimensional range of 0.1 to 2.5 mm, in a quantity equal to at least 50% by volume of the total volume of the mix, preferably between 55% and 65% by volume.

As an example of a preferred composition of the mix according to the present invention it is possible to mention the composition comprising 18% by volume of unsaturated polyester resin having a viscosity of 650 cps, 22% by volume of quartz filler with a fineness of 25,000 mesh and 60% by volume of quartz sand.

Obviously this composition is not intended nor to be understood as limiting the present invention, since the ingredients are also to be selected in consideration of the desired aesthetic features.

For a better understanding of the invention and its advantages, reference will now be made to the accompanying drawings and to the corresponding detailed description provided byway of a non-limiting example. In the drawings:

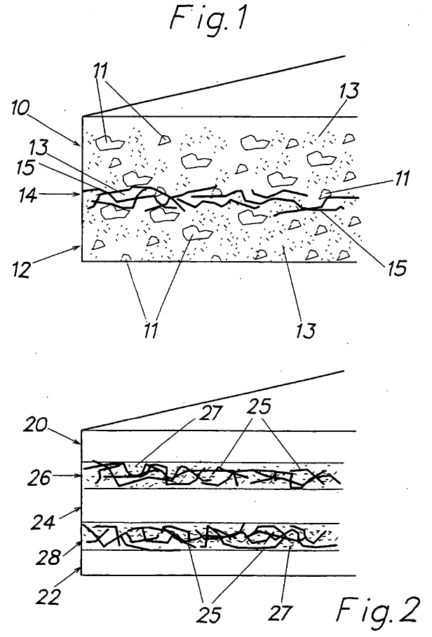

FIG. 1 is a partial perspective view of an embodiment of a slab according to the present invention;

FIG. 2 is a perspective view, similar to FIG. 1, of a variant of said embodiment of the slab.

Considering firstly FIG. 1, the final slab structure according to the present invention is shown in which the two outer layers of hardened mix are designated by the reference numerals 10 and 12, while the middle layer 14 (also called “fibrous layer” below) consists of non-woven glass filaments 15 between which part of the mix has infiltrated during the vibro-compression step, thereby establishing continuity between the two outer layers 10 and 12 through the middle layer 14. Within the layers 10 and 12, the particles of inert materials are designated by the reference numeral 11, while the binding paste formed by resin and filler is designated by the reference numeral 13.

From the drawing it can be seen how the glass filaments 15, which are pre-impregnated with resin and form the web or bundle of webs, have a sinuous configuration, which is partly due to the initial deposition of the web or bundle of webs and partly to the vibro-compaction step, during which the two outer layers penetrate into the webs and between the filaments, deforming them so that they no longer assume an orderly linear configuration in one plane. Therefore the web of glass filaments does not constitute a break or interruption in the mix forming the slab, but becomes an integral part of the structure of the said slab.

It should also be noted that a compacted slab, which for example after the resin hardening step has a thickness of 7.5 mm, after sizing of the two sides and polishing of the visible surface, will have a finished thickness of 5 mm, namely a fibrous or middle inner layer 14 with a thickness of 1.5 mm and two outer layers 10 and 12 with a thickness of 1.75 mm.

The results achieved by the present invention are even more surprising in comparison with the previously proposed use of glass filaments or fibres, preferably in woven form or in the form of short fibres distributed throughout the mix, in the art of manufacturing slabs of strong materials, particularly of slabs of composite stone materials. Actually, in both cases it was impossible to obtain the results achieved with the present invention, namely the combination of an extremely small thickness of the finished article, together with optimum mechanical properties and, obviously, excellent and repeatable aesthetic characteristics.

Without the risk of being regarded as a limitation of the invention, it seems plausible that, in the present invention, that the glass filaments or bundles of glass filaments must be impregnated with the above mentioned resin in order to ensure they assume the form of a web, namely a non-woven form with a sinuous configuration of the filaments, before being used to form the middle or fibre layer. In this way the filaments or bundles of filaments, although they are held or grouped together by the pre-impregnating resin, do not form a rigid structure, like that of a meshwork, matting or fabric, but are free to move within the mix during the vibro-compression step and the catalysis step during which substantial volumetric shrinkage occurs, being deformed and/or displaced vertically as well as performing horizontal displacements.

In this respect the slab structure according to the present invention differs from the conventional solutions of the art based in which a layer of resin added with fibres (i. e. the so-called fibre glass) forms an interruption in the continuity of the composite slab.

The slab according to the present invention differs also from those conventional structures where inorganic fibres or filaments, for example made of glass, are thoroughly added to the mix so as to be substantially distributed within the whole slab structure. In fact the fibres distributed throughout the mix have the serious drawback that they are visible after the final polishing of the visible surface, ruining the appearance of the product, something which is unacceptable from an aesthetic point of view. Moreover the thoroughly distributed fibres may not be present in the mix in a quantity such as to provide it with the necessary impact strength since a mix containing an excessively high fibre content could not be mixed nor even compacted.

In the solution according to the present invention, the middle layer 14 mainly consists of linear glass elements in the form of a web which does not create an interruption in the continuity of the mix.

FIG. 2 shows a possible variant of the invention which consists in manufacturing an article containing, within its thickness, instead of a single middle fibrous layer, two layers of fibrous mix spaced by layers of non-fibrous material, such as for example an article with a total thickness of 8.5 mm formed by: two outer layers of non-fibrous mix, two layers of fibrous mix adjacent to the two outer layers of non-fibrous mix and a central layer of non-fibrous mix, each one of said layers having a thickness of 1.7 mm.

More specifically, in the embodiment according to FIG. 2, the slab comprises three layers 20, 22 and 24 of hardened mix—the layers 20 and 22 of which are the outermost ones—and two fibrous middle layers 26 and 28, in which the pre-impregnated glass filaments deposited in the form of a web or bundle of webs can be seen and into which, following vibro-compaction, the mix parts indicated by the reference number 27 have penetrated.

The steps of deposition of each of the two fibrous layers composed of one or more webs in bundle form and the distribution of the mix for each of the three layers of non-fibrous mix are performed as in the above described embodiment where the article comprises a single central fibrous layer.

The products which are obtained through the method of the present invention have physical and mechanical properties which are far superior in comparison with any natural, artificial and/or composite stone material. The following table shows the comparative properties of various materials and Bretonstone reinforced with an internal quartz layer according to the present invention. UNI 10440 and 10443 are the applicable Italian standards.

COMPARATIVE STRENGTH TESTS CARRIED OUT ON
TEST SAMPLES WITH DIMENSIONS 20 × 20 CM

| | | | | UNI | | Linear |
|---|---|---|---|---|---|---|
| | | | UNI 10440 | 10443 | | thermal |
| | Thick- | Impact | Impact | Flexural | Elastic | expansion |
| | ness | height | strength | strength | modulus | coefficient |
| MATERIAL | (mm) | (cm) | (Joule) | (N/mm²) | (N/mm²) | (μm/m° C.) |
| Bretonstone | 3.50 | | | 58.0 | | 16 |
| according to | | | | | | |
| present invention | | | | | | |
| as per the above | | | | | | |
| example of | | | | | | |
| formulation - see | | | | | | |
| Bretonstone as | 5.50 | 65 | 6.38 | 57.8 | 39,500 | 16 |
| above with | | | | | | |
| different thickness | | | | | | |
| Conventional | 5.50 | 15 | 1.47 | 57.5 | 32,505 | 22 |
| quartz | | | | | | |
| Bretonstone | | | | | | |
| 0.1-2.5 mm | | | | | | |
| White Carrara | 5.50 | 10 | 0.98 | 17.8 | 56,500 | |
| marble | | | | | | |
| Pink Sardinian | 5.50 | 10 | 0.98 | 14.7 | 34,044 | |
| Granite | | | | | | |
| Bretonstone | 8.50 | 90 | 8.85 | 68.5 | 38,195 | 16 |
| according to | | | | | | |
| present invention | | | | | | |
| as per the above | | | | | | |
| example of | | | | | | |
| formulation with | | | | | | |
| two fibrous | | | | | | |
| layers - see | | | | | | |
| Conventional | 8.50 | 20 | 1.96 | 56.0 | 34,589 | 22 |
| quartz | | | | | | |
| Bretonstone | | | | | | |
| 0.1-2.5 mm | | | | | | |
| White Carrara | 8.50 | 20 | 1.96 | 17.00 | 56,300 | |
| marble | | | | | | |
| Pink Sardinian | 8.50 | 15 | 1.47 | 14.80 | 34,044 | |
| granite | | | | | | |
| Porcelain grès | 7.80 | 10 | 0.98 | 65.20 | 64,178 | |

The second column (labelled “impact height”) refers to the height from which a metal ball is dropped in order to cause breakage of the test piece; the third column indicates the impact strength, in accordance with that stipulated by the standard indicated.

It should be noted that the impact strength of the product according to this invention is at least four times greater than that of other natural or artificial stone products which are normally used in the building and furnishing sectors, so much so that they be manufactured with thicknesses as small as 3.5 millimetres.

In the slab structure according to the present invention the presence of the fibrous middle layer reduces by about 36% the value of the linear thermal expansion coefficient compared to conventional Bretonstone (the glass filaments have a linear thermal expansion coefficient of about 5 μm/m° C.); this coefficient diminishes in fact from 22 to 14 μm/m° C., namely a value which is close to the value of aluminium and stainless steel—an important factor for any application of the product in the building and furnishing sectors.

From the above table it can also be seen that in the embodiment according to FIG. 2, which comprises two fibrous layers instead of one, the flexural strength increases not only compared to conventional natural stone materials and conventional Bretonstone, but also compared to the slab structure according to FIG. 1 which comprises a single fibrous middle layer.

As already mentioned, comparing the thin slabs according to the present invention with the thicker slabs of the known prior art, it can be readily understood that there are differences in weight which result in major savings in terms of handling and transportation costs.In fact, the slabs according to the present invention with a thickness of 3.5 and 5 mm have a weight of 8.35 kg respectively 12 kg per square metre. The slabs of conventional Bretonstone and those of natural stone with thicknesses of 10, 20 and 30 mm have an average weight of 24, 48 and 72 kg per square metre, respectively.

Let us now consider as an example the case of a panel to be lined on a single surface and along the entire peripheral edge with a Bretonstone slab according to the present invention having a thickness of 3.5 mm, such as to form a lined panel with an overall thickness of 3 cm and surface area equal to 1 square metre. If the panel to be lined has a specific weight of 800 g/dm³, the following values are obtained:

the panel before lining has a weight of 20 kg;

the Bretonstone slab of 1 square meter according to the invention has a weight of 8 kg;

the peripheral edge made with Bretonstone according to the invention has a weight of 1 kg.

The overall weight of the final lined panel according to the invention with external dimensions of 100×100×3 cm is 29 kg, while a panel of equivalent dimensions made of natural stone or fully made of conventional Bretonstone would have an approximate weight of 78 kg, namely it would be three times heavier.

The advantages resulting therefrom are obvious in that the transportation, handling and machining of a panel lined in accordance with the present invention are greatly facilitated. It should be considered moreover that a final panel weighing 29 kg (and even more so a slab of 8 or 12 kg) may be easily moved even by one person, without requiring particular lifting or transportation equipment, unlike conventional full-thickness panels which require the presence of two or more persons, possibly with the use of special handling equipment.

1. Thin, stratified, reinforced slab of composite stone material or conglomerate comprising two outer layers of the same permanently hardened mix comprising inert materials and a binding resin and at least one resistant middle layer, characterized in that said at least one middle layer consists of linear elements or filaments having a sinuous configuration and being inorganic or organic with equivalent properties which are pre-impregnated with a resin of the same kind as, or at least compatible with, the binding resin of the outer layers so as to be embedded and adherent thereto.

2. Thin, stratified, reinforced slab according to claim 1, characterized in that said linear elements or filaments are continuous and made of glass.

3. Thin, stratified, reinforced slab according to claim 2, characterized in that said linear elements or filaments having a non-woven sinuous configuration are in the form of a web or bundle of webs formed with said filaments pre-impregnated with said resin.

4. Thin, stratified, reinforced slab according to claim 1, characterized in that said mix forming said outer layers and said at least one middle layer is a Bretonstone mix.

5. Thin, stratified, reinforced slab according to claim 1, characterized in that it comprises two of the said fibrous middle layers between which a layer of non-fibrous mix is arranged.

6. Thin, stratified, reinforced slab according to claim 1, characterized in that it has a thickness of 3.5 to 6 mm.

7. Method for manufacturing thin, stratified, reinforced slabs of composite stone material or conglomerate, comprising the steps of:
(a) preparing two sheets of rubber with a separating and protective agent spread over one of their surfaces;
(b) spreading in a uniform thickness onto one of said rubber sheets, in which the surface with the protective agent being turned upwards, a layer of mix formed by resin of a suitable viscosity, fillers and inert materials, the quantity of mix being equal to half of the total quantity needed for manufacturing a slab of the desired thickness;
(c) depositing on the surface of said layer of mix one or more webs arranged in bundle form, each web being formed by linear elements or filaments having a sinuous configuration and being inorganic or organic with equivalent properties which are pre-impregnated with a resin of the same kind as, or at least compatible with, the binding resin of said layer of mix;
(d) spreading on top of the said web or said webs, again with a uniform thickness, a second layer of the said mix, in the same quantity as the first layer,
(e) placing on top of the surface of said second layer of mix the the second rubber sheet, the surface with the protective agent being turned downwards, thus obtaining an assemby in which the rubber sheets enclose the sandwich formed by the two layers of mix and a middle layer of impregnated filaments;
(f) compacting by means of vacuum vibro-compression the said assembly until the layers of mix interpenetrate each other, embedding the filaments which form said web or webs, and the resin pre-impregnating the filaments bonds with the resin with which the layers of mix is formed without hardening;
(g) transferring the slab resulting from the compaction step, which results to be thin, stratified and reinforced, to a catalysis oven and heating until the resins are hardened;
(h) extracting the hardened slab and removing the rubber sheet.

8. Method according to claim 7, characterized in that said at least one web is formed by continuous filaments made of glass.

9. Method according to claim 7, characterized in that said at least one layer is in the form of a web formed with the filament or a bundle of non-woven continuous filaments already pre-impregnated with said resin.

10. Method according to claim 7, characterized in that the hardening step is performed in a catalysis oven comprising pairs of adjacent heating plates between which the compacted slab is enclosed at a temperature of between 90 and 130° C. and for a time period of between 10 and 20 minutes.

11. Method according to claim 11, characterized in that said mix has the following composition:
(a) an unsaturated polyester resin in a quantity equal to at least 15% of the total volume of the mix;
(b) a filler chosen preferably consisting of quartz ground to a fineness of about 25,000 mesh and in a quantity equivalent to at least 16% by volume of the total volume of the mix;
(c) inert materials, consisting preferably of quartz sand with a grain size calculated in accordance with Bolomey's or Fuller's formula comprised within the dimensional range of 0.1 to 2.5 mm, in a quantity equal to at least 50% by volume of the total volume of the mix.

12. Method according to claim 11, characterized in that said resin is in a quantity within the range 16 to 20% of the total volume of the mix.

13. Method according to claim 11, characterized in that said filler is in a quantity within the range 17 to 24% of the total volume of the mix.

14. Method according to claim 11, characterized in that said inert materials are in a quantity within the range 55% to 65% of the total volume of the mix.
